(19) United States
(12) Patent Application Publication
(10) Pub. No.: US 2010/0165686 A1
(43) Pub. Date: Jul. 1, 2010

(54) RECTIFIER CIRCUIT

(75) Inventors: Markus Matzberger, Tiefenbach (DE); Konrad Wagensohner, Mauern (DE); Erich-Johann Bayer, Thonhausen (DE)

Correspondence Address: TEXAS INSTRUMENTS INCORPORATED, P O BOX 655474, M/S 3999, DALLAS, TX, 75265, US

(73) Assignee: Texas Instruments Deutschland GmbH, Freising (DE)

(21) Appl. No.: 12/643,003

(22) Filed: Dec. 21, 2009

(30) Foreign Application Priority Data
Dec. 22, 2008 (DE) 10 2008 064 402.1

(51) Int. Cl. H02M 7/12

(52) U.S. Cl. 363/127

(57) ABSTRACT

A rectifier circuit for use in an energy harvesting application in which mechanical energy is converted into electrical energy by using an AC generator using an active rectifier bridge with a pair of input terminals adapted to be connected to an output of the AC generator and a pair of output terminals, an inductor connected across the output terminals of the active rectifier bridge and a storage capacitor. A pair of output switches selectively connects the storage capacitor across the inductor. A controller controls the active rectifier bridge and the pair of output switches such that in successive switching cycles within any half wave of AC input voltage from the output of the AC generator the inductor is first loaded by current from the output of the AC generator and then discharged into the storage capacitor. An energy harvesting system which uses an AC generator for generating electrical energy out of mechanical energy, a rectifier circuit which is connected with the input to the output of the AC generator and a low power wireless system as application unit. A method of rectifying an AC output voltage of an AC generator for use in an energy harvesting application.

### CROSS-REFERENCE TO RELATED APPLICATIONS

This patent application claims priority from German Application No. 10 2008 064 402.1, filed Dec. 22, 2008, the entirety which is incorporated herein by reference.

### FIELD OF THE INVENTION

The invention relates to a rectifier circuit for use in an energy harvesting application and a process of rectifying an AC output voltage. More particularly, the invention relates to a rectifier circuit comprising an active rectifier bridge.

### BACKGROUND OF THE INVENTION

In low power energy harvesting systems, inductive or piezo electric generators are used to generate electrical energy out of mechanical energy such as vibrations, pushbuttons press etc, in order to power low power wireless circuits (LPW systems).

The electric generators used to generate electrical energy out of mechanical energy are AC voltage generators. They behave like an AC generator with internal impedance. The AC voltage output depends on the kind of mechanical-electrical conversion used and can vary largely in frequency, duration of the signal and amplitude.

Low power wireless systems, on the other hand, need a DC supply voltage which typically does not exceed 3.6 volts.

The AC voltage output of the AC generator must be rectified for being usable by the low power wireless circuit and stored in a capacitor. Conventional systems use a full wave peak voltage bridge rectifier with diodes as shown in FIG. 1. A full wave peak voltage bridge is well known in the state of the art and has at all times two diodes connected in series with the output. Thus, there is always a voltage drop of twice the forward voltage V_{forward} of the diodes, which reduces power conversion efficiency. Additionally, with peak voltage rectification, only 50% of the generated energy in a half wave can be converted and stored in a storage capacitor, because during the falling edge of the AC signal the voltage output of the rectifier will be lower than the voltage already stored in the storage capacitor. For feeding the LPW system, a large storage capacitor is needed. This capacitor is connected to the output of the AC generator via the rectifier bridge which leads to an impedance mismatch between AC generator, bridge rectifier and capacitor, thus also reducing generator efficiency.

Therefore, there is a need for a rectifier circuit, which increases the efficiency of power conversion between the AC generator output and the stored energy in a storage capacitor.

### SUMMARY OF THE INVENTION

It is a general object of the invention to provide a rectifier circuit that can be used in low power energy harvesting systems with a low energy conversion loss.

An aspect of the invention provides a rectifier circuit which includes an active rectifier bridge with a pair of input terminals adapted to be connected to an output of the AC generator and a pair of output terminals. An inductor is connected across the output terminals of the active rectifier bridge. The rectifier circuit further includes a storage capacitor and a pair of output switches which can selectively connect the storage capacitor across the inductor. A controller is adapted to control the active rectifier bridge and the pair of output switches such that in successive switching cycles within any half wave of AC input voltage from the output of the AC generator the inductor is first loaded by current from the output of the AC generator and then discharged into the storage capacitor.

In an aspect of the inventive rectifier circuit, it does not need a bridge rectifier with diodes but, instead uses an active rectifier which reduces voltage drop during rectification. Specifically, there is no voltage drop over diodes as in the peak voltage bridge rectifier in the state of the art. The inventive rectifier rather performs an accumulated rectification with intermediate energy storage in an inductor. The inductor is first loaded by current from the AC input voltage when the inductor is coupled directly to the output of the AC generator and a current is flowing through the inductor.

Then the inductor is disconnected from the generator output and connected by the pair of output switches directly to the storage capacitor. Because of the common behavior of an inductor, the current through the inductor continues to flow discharging the inductor and charging the storage capacitor. In any half wave of AC input voltage successive switching cycles perform charging and discharging of the inductor. The number of successive switching cycles in a half wave depends on the kind of AC generator used. There may be 10 switching cycles in a half wave, but also many more, if the frequency of the AC input voltage is as low as 100 Hz for example. Storing energy in the storage capacitor is not limited to the peak voltage of the AC input voltage, because of the intermediate storage in the inductor. The inductance of the inductor and the capacitance of the storage capacitor are chosen accordingly to allow a current flow from the inductor into the storage capacitor to charge the storage capacitor to a voltage higher than the peak voltage of the AC input voltage. Thus, the efficiency of the rectifier is considerably increased compared to the bridge converter in the state of the art.

In an aspect of the invention a decoupling capacitor which is adapted to average a peak current into the active rectifier bridge is connected across the input of the rectifier circuit. The capacitance of the decoupling capacitor is substantially smaller than the capacitance of the storage capacitor. While the inductor is disconnected from the AC generator and coupled to the storage capacitor, the coupling capacitor acts as intermediate energy store for the energy output from the AC generator. The optimal capacitance of the coupling capacitor is dependent on the relation between the frequency of the AC output signal of the generator, the cycle time T and the time interval t₁ during which the inductor is charged and may be for example a tenth or a hundredth of the storage capacitance.

In one aspect of the invention the ratio between the time interval t₁ during which the inductor is loaded to the duration T of a switching cycle is adjusted to match the internal impedance of the AC generator. In fact, the impedance of the rectifier circuit is given by the quotient out of the generator output voltage divided by the average current into the decoupling capacitor which is connected across the AC generator output. The average current is given by the quotient out of the peak current into the inductor multiplied by time interval t₁ and divided by cycle time T. Thus, the variation of these parameters defines the impedance matching to the generator. The generator does not “see” any more the large capacitance of the storage capacitor.

In one aspect of the invention the rectifier circuit further comprises a polarity detector for detecting the polarity of the AC output signal of the AC generator and to output a polarity signal. The polarity signal may be used by an application unit, for example a low power wireless system which is fed by the rectifier circuit. In an embodiment, the AC generator may be realized for example as a push button, which is pressed down to start a lamp. Any activation of the push button generates a defined number of AC voltage waves. The polarity signal output from the rectifier circuit to the low power wireless system allows the system for example to count the number of AC voltage waves generated and to infer the number of times the push button has be pressed down. The LPW system may then send a radio telegram to the lamp according to the number of times the push button has been activated; pressing the push button twice may start two lamps or start one lamp with higher intensity, etc.

In an aspect of the invention the rectifier includes a DC/DC converter which is coupled to the storage capacitor output for converting a voltage which is stored in the storage capacitor to a voltage value which is needed by the application system which is supplied by the rectifier circuit.

In an aspect of the invention, the controller is further adapted to control the switches to perform an overvoltage protection by shortcutting the AC generator when the output voltage of the AC generator or the voltage stored in the storage capacitor exceeds a maximum voltage. The switches of the active rectifier bridge can be used for the overvoltage protection. There is no need for additional circuitry.

An aspect of the invention further provides an energy harvesting system which includes an AC generator for generating electrical energy out of mechanical energy, a rectifier circuit according to the invention which is connected to the output of the AC generator, and a low power wireless system.

An aspect of the invention further comprises a method of rectifying an AC output voltage of an AC generator for use in an energy harvesting application in which mechanical energy is converted into electrical energy.

### BRIEF DESCRIPTION OF THE DRAWINGS

The benefits of the inventive rectifier circuit will become apparent from the following detailed description of an example embodiment with reference to the appended drawings, in which

FIG. 1 is a simplified schematic of an energy harvesting system according to the state of the art;

FIG. 2 is a simplified schematic of an energy harvesting system according to the invention; and

FIG. 3 is a diagram of the time behavior of voltages and currents in a rectifier circuit according to the invention.

### DETAILED DESCRIPTION OF AN EXAMPLE EMBODIMENT

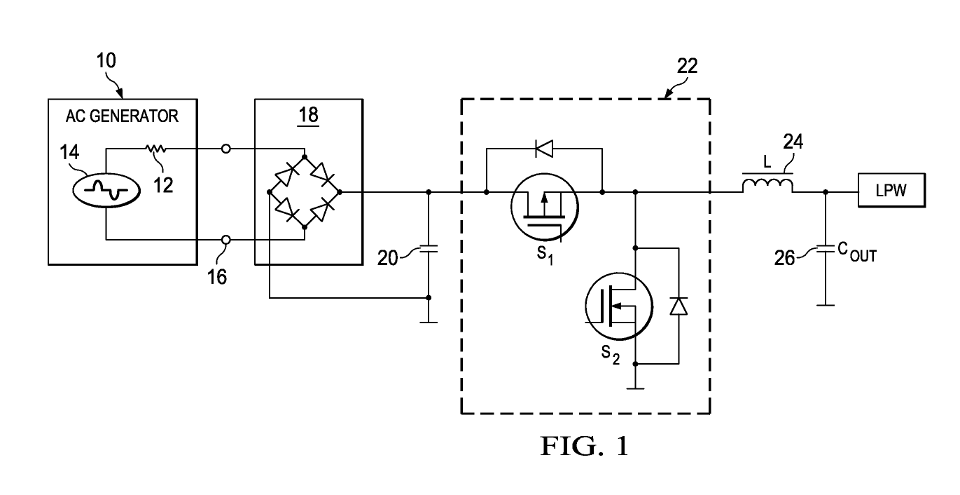

FIG. 1 shows in a simplified schematic an energy harvesting system of the state of the art. An AC generator 10 comprises a generator impedance 12 and outputs an AC voltage with a waveform as indicated in a simplified manner under reference sign 14. An output 16 of the AC generator 10 is connected to an input of a full bridge rectifier 18 formed by four diodes. A storage capacitor 20 is connected with its two terminals to the output of the rectifier diode bridge. One terminal of the storage capacitor 20 is further connected to ground. The other terminal of the storage capacitor 20 is connected to a buck converter 22. The buck converter comprises two switches S1 and S2 formed by MOS FET transistors. The terminal of the storage capacitor 20 which is coupled to the buck converter 22 is connected to a drain of transistor S1 and the source of transistor S1 is connected to a drain of transistor S2. A source of transistor S2 is connected to ground. Transistors S1 and S2 together with an inductor L and a capacitor Cout form in a well known manner a synchronous converter which allows controlling the output voltage by controlling the on and off times of transistors S1 and S2. In the example given for the state in the art the output voltage lies at about 2 volts with a current of about 1 μA up to about 30 mA. This downstream buck converter may be integrated or built from external components. It converts the higher voltage of the storage element to a voltage level, which is optimized for the LPW system and protects the LPW system against overvoltage.

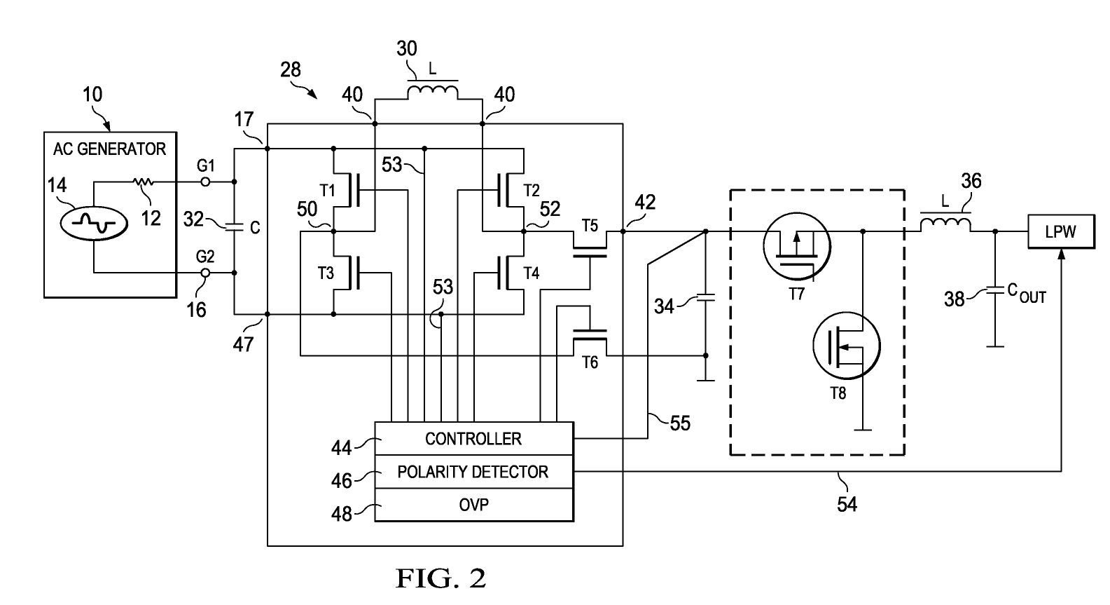

FIG. 2 shows a simplified schematic of an energy harvesting system which comprises an inventive rectifier circuit. Components which may be the same as in FIG. 1 are designated with the same reference signs. As in the state of the art an AC generator 10 converts mechanical energy into electrical energy outputting an AC output voltage as shown in a schematic example way with reference sign 14. The AC generator behaves like an AC generator with an internal impedance 12. The output 16 of the AC generator is coupled to a pair of input terminals 17 of a rectifier circuit 28. The rectifier circuit 28 comprises an active rectifier bridge T1, T2, T3, T4, two output switches T5 and T6, a controller 44, a polarity detector 46 and an overvoltage protection circuit 48. The energy harvesting system further comprises an inductor 30, a decoupling capacitor 32, a storage capacitor 34, a buck converter comprising two MOS transistors: PMOS transistor T7 and NMOS transistor T8, an inductor 36 and a capacitor 38. The energy generated by AC generator 10, rectified by rectifier circuit 28 and down converted by the buck converter is supplied to a low power wireless system LPW.

In more detail, the output 16 of the AC generator 10 comprises two terminals G1 and G2 which are connected to the pair of input terminals 17 of the active rectifier bridge of the rectifier circuit 28. The decoupling capacitor 32, which is a capacitor with a small capacitance compared to the storage capacitor 34, is connected across the terminals G1 and G2 of the generator output. A possible value for the decoupling capacitor 32 would be 0.5 to 5 μF and a possible value for the storage capacitor 34 would be about 50 μF. A pair of output terminals 40 of the active rectifier bridge is connected to the inductor 30. A pair of output terminals 42 of the rectifier circuit 28 is connected to the storage capacitor 34 and one of the terminals of the storage capacitor 34 is connected to ground as well. The other terminal of the storage capacitor 34 is connected to an input of the buck converter, more specifically connected to a drain of PMOS transistor T7. The source of PMOS transistor T7 is connected to a drain of NMOS transistor T8. A source of NMOS transistor T8 is connected to ground. An interconnecting node between the source of PMOS transistor T7 and the drain of NMOS transistor T8 is connected to a first terminal of the inductor 36. The inductor 36 is connected with the other terminal to the input of the low power wireless system LPW and to a terminal of a capacitor C_{OUT} 38. The capacitor C_{OUT} 38 is connected with its other terminal to ground.

Now rectifier circuit 28 will be described in more detail. The rectifier circuit 28 comprises six switches which are realized by MOSFET transistors T1, T2, T3, T4, T5 and T6. As well known, a MOS transistor comprises a channel which extends from the drain of the transistor to the source of the transistor and a gate which controls the current flow in the channel. As the rectifier circuit may be realized by NMOS or PMOS transistors, in the description there is no distinction between drain and source but rather the terms “channel” and the “two terminals of the transistor channel” will be used. Transistors T1, T2, T3 and T4 form in a well known manner an active rectifier bridge, whereas transistors T5 and T6 form a pair of output switches.

The rectifier circuit 28 further comprises the controller 44, the polarity detector 46 and the overvoltage protection 48. All transistors T1 to T6 are connected with their respective gate to controller 44, so that controller 44 can control the timing of opening and closing of all transistors T1 to T6 in rectifier circuit 28.

The channels of transistors T1 and T3 are connected in series and the series connection is connected in parallel with the decoupling capacitor 32. An interconnecting node 50 between transistors T1 and T3 is connected to a first terminal of the pair of output terminals 40. Node 50 is further connected to the channel of transistor T6, one of the output switches, the other channel terminal of which is connected to a first terminal of the storage capacitor 34 and to ground.

The channels of transistors T2 and T4 are connected in series and the series connection is connected in parallel to decoupling capacitor 32 and to the series connection of transistors T1 and T3. An interconnecting node 52 between transistor T2 and transistor T4 is connected to the second terminal of the pair of output terminals 40 and to a first terminal of the channel of transistor T5, one of the output switches. The other terminal of the channel of transistor T5 is connected to a second terminal of the storage capacitor 34 and to the input of the buck converter.

The controller 44 is further connected by connection lines 53 to the pair of input terminals 17. The controller 44 is further connected by a line 55 to the second terminal of the storage capacitor 34 and to the input of the buck converter. The polarity detector 46 outputs a signal on a line 54 to the LPW system. The three blocks designated “controller”, “polarity detector” and overvoltage protection “OVP” are to be understood as functional blocks rather than as distinct circuits. In fact, the controller also performs the polarity detection and the overvoltage protection.

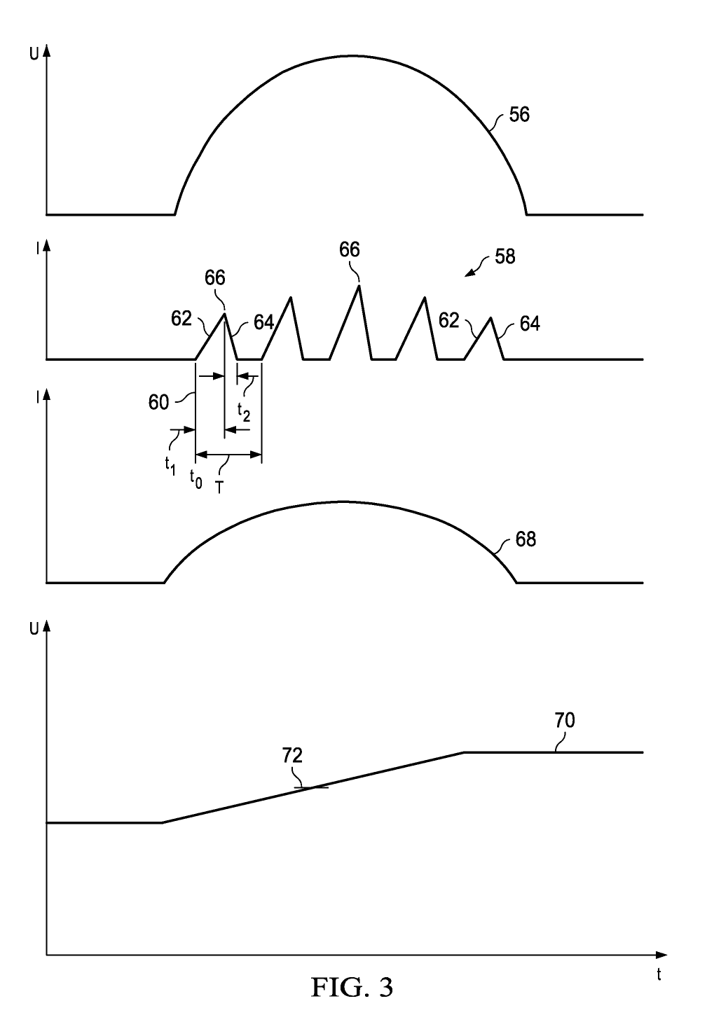

Operation of the energy harvesting system will now be explained with reference to FIGS. 2 and 3. The controller 44 can detect via lines 53 whether the AC generator 10 outputs a voltage signal. When the voltage is higher than a given threshold value, the rectifier circuit starts operation. AC generator 10 outputs an AC output voltage between terminals G1 and G2. In the case of a positive half wave of the AC output voltage, terminal G1 is positive, whereas G2 is negative. In a first partial cycle, during a time interval t₁ transistors T1 and T4 are closed and transistors T2, T3, T5 and T6 are opened by corresponding control signals. Consequently, inductor 30 is connected across the input terminals G1 and G2 of the AC generator 10 and in parallel to decoupling capacitor 32. Thus, there is a current flowing through inductor 30.

FIG. 3 shows the time behavior of the output signal of the AC generator by a line 56. Only a positive half wave is shown.

A diagram 58 shows the timing of the current flowing through inductor 30. At a time t₀ designated with reference sign 60 transistors T1 and T4 are closed and transistors T2, T3, T5 and T6 are opened and the first partial cycle starts for a time interval t₁ during which the inductor 30 is loaded. In the first partial cycle, i.e. during the time interval t₁, a current I_{L} 62 flows through inductor 30. After the time interval t₁ the transistors T1 and T4 are opened and output switches T5 and T6 are closed, the second partial cycle starts, in which the inductor is discharged into the storage capacitor 34. Consequently, inductor 30 is connected in parallel to storage capacitor 34 and disconnected from the AC generator 10. The energy stored in the inductor leads to a current 64 during time interval t₂ in the same direction as the current I_{L} 60 during time interval t₁. As there is no voltage supplied to the inductor 30 during the second partial cycle, the current 64 decreases over time. The current 64 transfers the energy stored in inductor 30 into storage capacitor 34. During the time when the inductor 30 is discharged into storage capacitor 34, the decoupling capacitor 32 is still connected to the AC generator and is charged by the AC input voltage.

The controller 44 detects via line 55 when the current 64 becomes 0. Then output switches T5 and T6 are reopened. After a cycle time T the first partial cycle restarts by closing transistors T1 and T4. Again, a current I_{L} 62 charges the inductor 30. The peak current 66 at the end of time interval t₁ is dependent on the output voltage of the AC generator at the time when transistors T1 and T4 are closed, the internal impedance 12 of the AC generator and the time length of time interval t₁. In the case represented in diagram 58 there are five cycles with a cycle time length of T each for one positive half wave, but there may be more or less cycles in a half wave. The highest peak current is obtained during the third cycle which occurs when the positive half wave of the output voltage signal is at its maximum. The decoupling capacitor 32 averages the peak current. The average current is calculated by the peak current multiplied by the time interval t₁ divided by the cycle time interval T.

I_{Peak}

Average current=

The impedance the AC generator sees, i.e. the input impedance of the rectifier circuit is calculated by the generator output voltage divided by the average current into the decoupling capacitor.

$$Impedance of rectifier circuit = \frac{generator output voltage}{average current into decoupling capacitor}$$

By adjusting the peak current I_{Peak}, the time interval t₁ and the cycle time T the impedance of the rectifier circuit can be matched to the generator impedance thus improving the efficiency of energy conversion.

When the polarity detector detects a change in the polarity of the AC output signal, i.e. when G1 becomes negative and G2 becomes positive, transistors T2 and T3 are closed in the first partial cycle, whereas transistors T1, T4, T5 and T6 remain open. Thus, as for the positive half wave, inductor 30 is connected parallel to the decoupling capacitor 32 but in the opposite direction as for the positive half wave. This is the usual behavior of an active rectifier bridge. Thus, the connection node 50 is connected again to the positive terminal of the AC generator output and the other connection node 52 is connected again to the negative terminal of AC generator 10. After time interval t₁, the first partial cycle during which the inductor 30 is charged terminates and transistors T3 and T2 are opened by controller 44. The output switches T5 and T6 are now closed to connect inductor 30 to storage capacitor 34. As explained before, inductor 30 is discharged into storage capacitor 34 until the controller detects via line 55 that the current in the inductor 30 becomes 0. Then output switches T5 and T6 are opened and after cycle time T elapsed, the next switching cycle starts.

In case an overvoltage is detected, i.e. when the AC generator voltage or the voltage on the storage capacitor 34 exceeds a maximum voltage which can be handled by the LPW circuit, the generator will be short circuited by closing transistors T1 and T3. Advantageously, the polarity detector is adapted to deliver a polarity signal by a connection line 55 to the low power wireless circuit LPW. Depending on the system the polarity signal may include information necessary to the LPW, as the number of times a push button which acts as AC generator has been pressed, or in the case the AC generator transforms mechanical vibration energy, the frequency of the vibration or the absence of vibration can be detected.

FIG. 3 further shows in a diagram 68 the current output from the AC generator which is the current input into the decoupling capacitor 32. The current follows the form of the half wave of the AC output signal. A diagram 70 shows the time behavior of the voltage stored in storage capacitor 34. A line 72 indicates the voltage obtainable by the state of the art peak rectification using a full bridge rectifier whereas the inventive rectifier circuit allows an accumulated rectification and thus a voltage stored in the storage capacitor which is higher, because the whole energy of each half wave can be transferred to storage capacitor 34.

By using the full bridge active rectifier circuit 28 the efficiency is considerably increased and thus a smaller AC generator 10 can be used for the same output power delivered to the LPW circuit. Thus the invention allows a smaller dimensioned and cheaper AC generator. Advantageously the downstream buck converter can be integrated into the same device together with the rectifier circuit 28. In the embodiment shown the voltage delivered to the low power wireless system is comprised between 1.8 and 2 volts with a current between about 1 μA up to about 30 mA.

An embodiment of the present invention has been explained above. The present invention, however, is not limited to said embodiment. Various kinds of modifications, substitutions and alterations can be made within the scope of the technical idea of the present invention as defined by the appended claims.

1. A rectifier circuit for use in an energy harvesting application in which mechanical energy is converted into electrical energy using an AC generator, comprising:
an active rectifier bridge with a pair of input terminals adapted to be connected to an output of the AC generator and a pair of output terminals;
an inductor connected across the output terminals of the active rectifier bridge;
a storage capacitor;
a pair of output switches selectively connecting the storage capacitor across the inductor; and
a controller for controlling the active rectifier bridge and the pair of output switches such that in successive switching cycles within any half wave of AC input voltage from the output of the AC generator the inductor is first loaded by current from the output of the AC generator and then discharged into the storage capacitor.

2. The circuit of claim 1, wherein a decoupling capacitor is connected across the input terminals of the active rectifier bridge, the decoupling capacitor being smaller than the storage capacitor and adapted to average a peak current into the active rectifier bridge.

3. The circuit of claim 1, wherein the ratio of a
time interval t₁ during which the inductor is loaded to the duration T of a switching cycle is adjusted to match the internal impedance of the AC generator.

4. The circuit of any of claim 1, further comprising:
a DC/DC converter fed from the storage capacitor and supplying an application unit.

5. The circuit of any of claim 2, further comprising:
a DC/DC converter fed from the storage capacitor and supplying an application unit.

6. The circuit of any of claim 3, further comprising:
a DC/DC converter fed from the storage capacitor and supplying an application unit.

7. The circuit of claim 1, wherein the controller is further adapted to control the active rectifier bridge to perform an overvoltage protection by short circuiting the AC generator when the output voltage of the AC generator or the voltage stored in the storage capacitor exceeds a maximum voltage.

8. The circuit of claim 1, further comprising a polarity detector adapted to output a polarity signal.

9. The circuit of claim 1, wherein the controller is further adapted to sense the AC generator output voltage and to start operation of the rectifier circuit when the sensed voltage is higher than a given threshold value.

10. An energy harvesting system, comprising:
an AC generator for generating electrical energy out of mechanical energy;
a rectifier circuit according to claim 1, connected with the input to the output of the AC generator; and
a low power wireless system as application unit.

11. An energy harvesting system, comprising:
an AC generator for generating electrical energy out of mechanical energy;
a rectifier circuit according to claim 2, connected with the input to the output of the AC generator; and
a low power wireless system as application unit.

12. An energy harvesting system, comprising:
an AC generator for generating electrical energy out of mechanical energy;
a rectifier circuit according to claim 3, connected with the input to the output of the AC generator; and
a low power wireless system as application unit.

13. An energy harvesting system, comprising:
an AC generator for generating electrical energy out of mechanical energy;
a rectifier circuit according to claim 4, connected with the input to the output of the AC generator; and
a low power wireless system as application unit.

14. An energy harvesting system, comprising:
an AC generator for generating electrical energy out of mechanical energy;
a rectifier circuit according to claim 5, connected with the input to the output of the AC generator; and
a low power wireless system as application unit.

15. An energy harvesting system, comprising:
an AC generator for generating electrical energy out of mechanical energy;
a rectifier circuit according to claim 6, connected with the input to the output of the AC generator; and
a low power wireless system as application unit.

16. An energy harvesting system, comprising:
an AC generator for generating electrical energy out of mechanical energy;
a rectifier circuit according to claim 7, connected with the input to the output of the AC generator; and
a low power wireless system as application unit.

17. A method of rectifying an AC output voltage of an AC generator for use in an energy harvesting application in which mechanical energy is converted into electrical energy, comprising:
providing an active rectifier bridge which is connected with input terminals to an output of the AC generator and with output terminals to an inductor; and
in successive switching cycles of a duration T within any half wave of the AC output voltage:
loading the inductor by current from the output of the AC generator during a first time interval t₁ of each switching cycle;
controlling the active rectifier bridge to disconnect after the time interval t₁ the inductor from the output of the AC generator and connecting the inductor to a storage capacitor;
discharging during a second time interval of each switching cycle the energy stored in the inductor into the storage capacitor.
